(19) United States
(12) Patent Application Publication
(10) Pub. No.: US 2015/0244290 A1
(43) Pub. Date: Aug. 27, 2015

(54) SYSTEM AND METHOD FOR REGENERATIVE BRAKING IN ELECTRIC DRIVE SYSTEM

(71) Applicant: Caterpillar Inc., Peoria, IL (US)

(72) Inventors: Baojun Si, Dunlap, IL (US); Dustin Selvey, Peoria, IL (US); William J. Tate, Dunlap, IL (US); Michael Jensen, Dunlap, IL (US)

(73) Assignee: Caterpillar Inc., Peoria, IL (US)

(21) Appl. No.: 14/711,846

(22) Filed: May 14, 2015

(51) Int. Cl. H02P 3/14

(52) U.S. Cl. CPC H02P 3/14

(57) ABSTRACT

The present disclosure is related to a method for regenerative braking of a machine. The machine includes an electric drive assembly. The electric drive assembly includes a generator, a motor and a direct current bus and a regenerative brake assembly disposed between them. The regenerative braking assembly includes an inverter. The method includes connecting a phase leg between the direct current bus and the inverter. The phase leg includes an inductor and an electric switch. The phase leg boosts the regenerative voltage. The boosted regenerative voltage is then fed back to control a braking torque from the motor and directed back to the generator.

### TECHNICAL FIELD

The present disclosure relates to an electric drive system, and more particularly to a system and method for regenerative braking in the electric drive system.

### BACKGROUND

Machines, such as mining trucks during retardation, use devices such as retarding grid or resistors to burn off the retarding power. The retarding power is dissipated in the form of heat. This process increases the fuel consumption and consequently reduces the fuel efficiency, thereby increasing the cost of maintenance of the machine.

U. S. Published Application 2010/0085787, hereinafter referred to as the '787 application, describes a drive system that includes a first bus, a second bus, an AC bus, an energy storage device coupled to the first bus. However, the '787 application does not address improving performance of the braking system.

### SUMMARY OF THE DISCLOSURE

In one aspect of the present disclosure, a method for regenerative braking associated with a machine is provided. The machine includes a regenerative braking assembly connected between a motor and a generator via a direct current bus. Further, the regenerative braking assembly includes an inverter. The method includes connecting a phase leg between the direct current bus and the inverter associated with the regenerative braking assembly. Further, the phase leg includes an inductor and an electric switch associated with at least one of regulating and boosting a voltage fed back to the generator based on a duty cycle of the electric switch. Further, the voltage fed back to the generator is configured to control a braking torque from the motor directed back up to the generator.

Other features and aspects of this disclosure will be apparent from the following description and the accompanying drawings.

### BRIEF DESCRIPTION OF THE DRAWINGS

FIG. 1 is a side view of an exemplary machine having a regenerative braking system, according to an embodiment of the present disclosure;

FIG. 2 is a circuit diagram of an electric drive assembly, according to an embodiment of the present disclosure; and

FIG. 3 is a flowchart of a method for regenerative braking, according to an embodiment of the present disclosure.

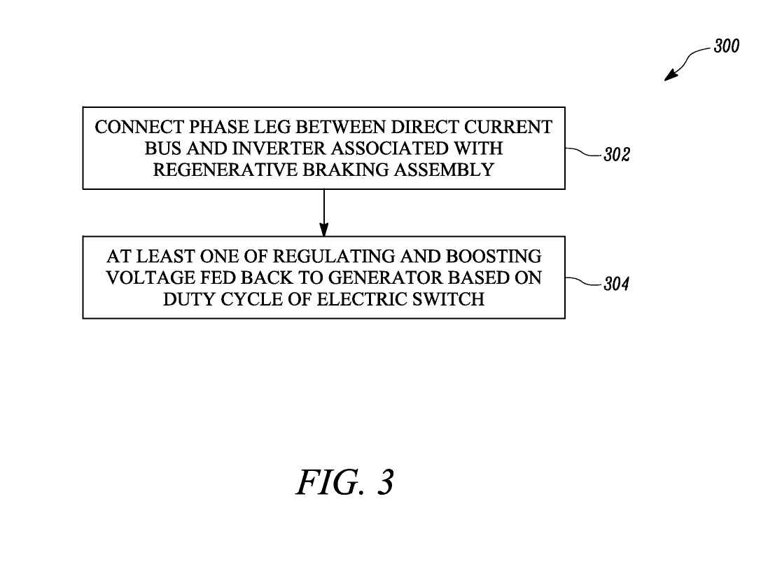

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

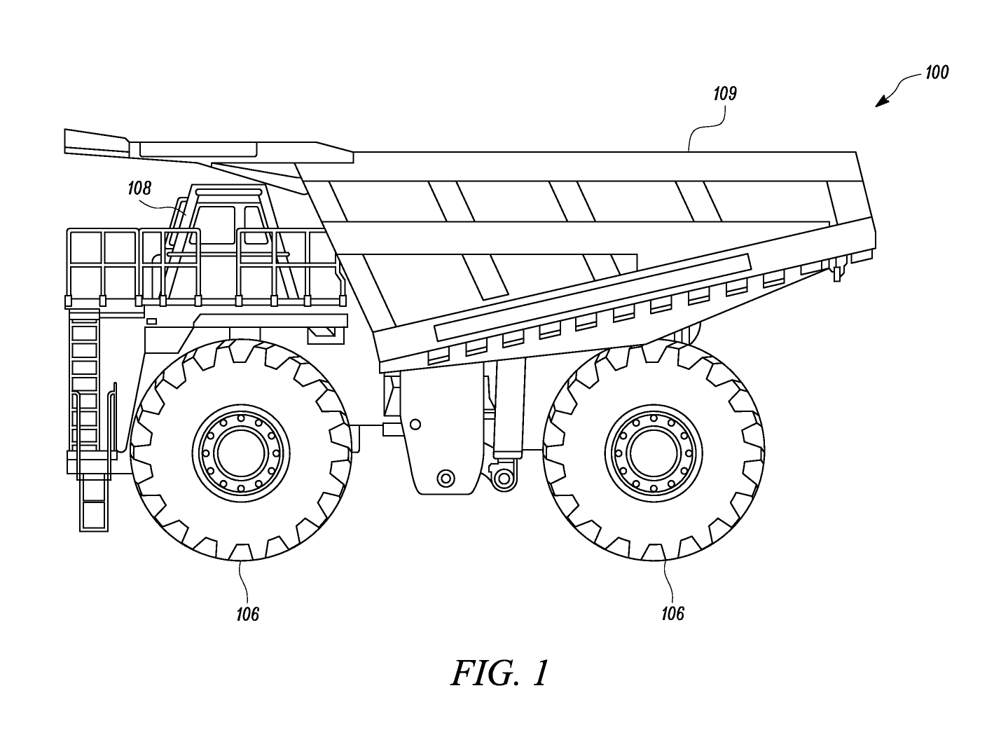

Referring to FIG. 1, an exemplary machine 100 is illustrated according to one embodiment of the present disclosure. The machine 100 is a mining truck. Alternatively, the machine 100 may include any other machine 100, such as, for example, an excavator, a loader, a dozer, a track type tractor, or any other machine or engine system including an electric drive system.

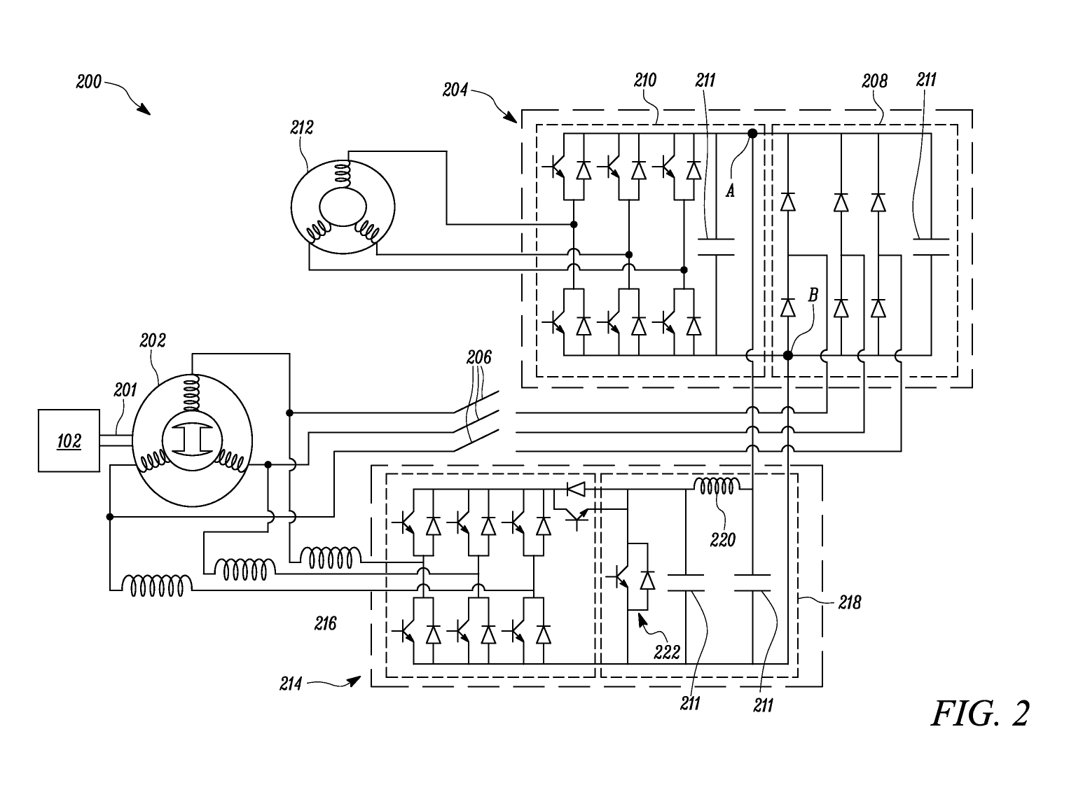

The machine 100 includes an engine 102 (see FIG. 2) and an electric drive assembly 200 (see FIG. 2) connected to wheels 106 of the machine 100. The engine 102 may be an internal combustion engine which runs on diesel, gasoline, gaseous fuels, or a combination thereof. The engine 102 may be of various configurations, such as in-line, V-type etc. Further, the engine 102 may provide power to various components of the machine 100, such as, the electric drive assembly 200. It is contemplated that the electric drive assembly 200 may be used with another type of power source such as, for example, a fuel cell.

The machine 100 includes an operator cabin 108 disposed above the electric drive assembly 200 and an implement 109, that is a dump body. In an alternate embodiment the implement 109 may be a bucket, ripper and the like. The operator cabin 108 includes an operator seat (not shown) and multiple control devices (not shown) configured to control the machine 100 for various operations.

The present disclosure relates to improving regenerative brake performance associated with the electric drive assembly 200 of the machine 100 and will be described in detail in connection with FIG. 2. Referring to FIG. 2 a circuit diagram of the electric drive assembly 200 is illustrated, according to one embodiment of the present disclosure. The electric drive assembly 200 includes a generator 202 drivably coupled to the engine 102, by an output shaft 201.

The generator 202 is configured to convert mechanical energy to electrical energy. The generator 202 may be a three-phase permanent magnet alternating field-type generator configured to produce a power output in response to a rotational input from the engine 102. It is also contemplated that the generator 202 may be a switched reluctance generator, a direct phase generator, or any other appropriate type of generator known in the art. The generator 202 may include a rotor (not shown) rotatably connected to the engine 102 by any means known in the art such as, for example, by the shaft, via a gear train, through a hydraulic circuit, or in any other appropriate manner. The generator 202 may be configured to produce electrical power output as the rotor is rotated within a stator (not shown) by the engine 102.

Further, the electric drive assembly 200 includes a direct current bus 204. The direct current bus 204 is connected to the generator 202 by means of mechanical switches 206. The direct current bus 204 includes a rectifier circuit grid 208 and a traction inverter circuit grid 210. An energy storage device 211 such as, for example, a capacitor, or any other type of known supercapacitor, ultracapacitor, or battery is provided across the rectifier circuit grid 208 and the traction inverter circuit grid 210. The rectifier circuit grid 208 converts alternating current from the generator 202 to direct current.

The direct current bus 204 supplies power to the traction inverter circuit grid 210 where insulated gate bipolar transistors convert the direct current signal to 3-phase alternating current to drive a motor 212. In the exemplary embodiment, the output from the motor 212 drives the wheels 106 through a double reduction final drive (not shown). The motor 212 may be a permanent magnet alternating field-type motor configured to receive power from the direct current bus 204 and to cause movement of the wheels 106 of the machine 100. The motor 212 may be a direct current induction motor that converts the electrical energy into mechanical energy. It is also contemplated that the motor 212 may be a switched electric motor, a direct phase motor, or any other appropriate type of motor known in the art. In the exemplary embodiment, the motor 212 is a three phase alternating current induction motor. The motor 212 may be connected to the wheels 106 with a direct shaft coupling, a gear mechanism, or in any other manner known in the art. In an embodiment, there may be one or more motors 212 coupled to each set of the wheels 106 of the machine 100. The motor 212 is configured to rotate or brake the wheels 106.

The electric drive assembly 200 includes a regenerative braking assembly 214 connected between the generator 202 and the motor 212 through the direct current bus 204. The regenerative braking assembly 214 is connected to the direct current bus 204 through nodes “A” and “B” at an input side of the regenerative braking assembly 214. The generator 202 is at an output side of the regenerative braking assembly 214. The regenerative braking assembly 214 includes an inverter circuit grid 216. The inverter circuit grid 216 converts direct current to alternating current. The inverter circuit grid 216 includes a three-phase inverter, connecting the motor 212 to the generator 202. The electric drive assembly 200 may additionally include a controller (not shown) in communication with the motor 212, the generator 202, and the direct current bus 204.

The present disclosure relates to a phase leg 218 connected between the direct current bus 204 and the inverter circuit grid 216 of the regenerative braking assembly 214. The phase leg 218 includes an inductor 220 and an electric switch 222 associated therewith. The inductor 220 stores electrical energy and supplies this energy to the generator 202 via the inverter circuit grid 216 during regenerative braking. The electric switch 222 is configured to periodically connect or disconnect the inductor 220 based on a duty cycle of the electric switch 222.

An inductance of the inductor 220 and duty cycle of the electric switch 222 may be selected based on the application. The phase leg 218 also includes capacitors 211 connected in parallel across the inductor 220. The phase leg 218 provided at the regenerative braking assembly 214 is configured to control a voltage fed into the inverter circuit grid 216 and a voltage fed back to the generator 202. The operation of the phase leg 218 during regenerative braking will be described in detail later in this section.

During the operation of the machine 100, the engine 102 drives the generator 202 by the input shaft 201. The generator 202 produces alternating current. The alternating current is supplied to the direct current bus 204 through the mechanical switches 206 that are closed during normal operation. The alternating current is rectified to direct current by the rectifier circuit grid 208 of the direct current bus 204. The rectified direct current is then supplied to the motor 212 via the traction inverter circuit grid 210.

Whenever brakes are applied to the machine 100 to slow the machine 100, energy is removed from the machine 100. The faster the machine 100 travelled just before applying the brakes, the more energy is available at the wheels 106 of the machine 100. Brakes of the machine 100 can capture some of this energy by using regenerative braking. That is, instead of using the brakes to stop the machine 100, the motor 212 may also slow the machine 100 by acting as a generator while the machine 100 is slowing down.

During regenerative braking, the mechanical switches 206 are open. In this situation, the direct current bus 204 provides a retarding energy flow path connecting the motor 212 to the generator 206. Accordingly, the power from the motor 212 is fed back through the direct current bus 204. The operation of the mechanical switches 206 may be controlled by the controller (not shown). The motor 212 produces a braking torque that generates a regenerative voltage of certain potential, say “V1”, across nodes “A” and “B” of the direct current bus 204. The voltage “V1” may be, for example, approximately between 2700 V and 1300 V.

As described earlier, the phase leg 218 is configured to regulate or boost the voltage “V1” into the inverter circuit grid 216. Accordingly, if the voltage “V1” is high or above a certain threshold, the voltage “V1” may be regulated and fed into the inverter circuit grid 216. In another situation, when the voltage “V1” is below the threshold, the electric switch 222 is in a closed condition to charge the inductor 220. After some time, the electric switch 222 is changed to an open condition. Accordingly, in this case, the energy stored in the inductor 220 of the phase leg 218 is utilized to boost the voltage “V1” fed into the inverter circuit grid 216 and further to the generator 202. The voltage “V1” fed back to the generator 202 is used to motor the generator 202 and torque the engine 102.

### INDUSTRIAL APPLICABILITY

The present disclosure relates to machines 100 that include the engine 102 that drives the generator 202. The generator 202 transfers power to the motor 212 through the direct current bus 204 that in turn provides motion to the machine 100. During regenerative braking, the braking torque is generated in the motor 212 and the regenerative braking assembly 214 is configured to direct the secondary power or retarding power back to the generator 202.

A method 300 of improving the regenerative braking by regulating or boosting the voltage “V1” fed back to the generator 202 during regenerative braking is also provided. Further, the present disclosure allows for conversion of electrical energy back to mechanical energy at a flywheel of the engine 102 by driving the generator 202 as a motor. At step 302, the phase leg 218 is connected between the direct current bus 204 and the inverter circuit grid 216 within the regenerative braking assembly 214. At step 304, during regenerative braking, the phase leg 218 regulates or boosts the voltage “V1” fed back to the generator 202.

Accordingly, the engine 102 is selectively operated to achieve the desired torque and thereby reduces fuel consumption during regenerative braking. Further, the engine 102 provides power to other components, such as the hydraulic pumps, Heating, Ventilation and Air Conditioning (HVAC) system, and so on. The phase leg 218 allows for improving the performance of the regenerative braking assembly 214.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for regenerative braking associated with a machine, wherein a regenerative braking assembly is connected between a motor and a generator via a direct current bus, the regenerative braking assembly including an inverter, the method comprising:
connecting a phase leg between the direct current bus and the inverter associated with the regenerative braking assembly, wherein the phase leg includes an inductor and an electric switch associated therewith; and
at least one of regulating and boosting a voltage fed back to the generator based on a duty cycle of the electric switch, wherein the voltage fed back to the generator is configured to control a braking torque from the motor directed back up to the generator.
